(19) United States
(12) Patent Application Publication
(10) Pub. No.: US 2026/0066974 A1
(43) Pub. Date: Mar. 5, 2026

(54) COMMUNICATION METHOD, APPARATUS AND DEVICE, STORAGE MEDIUM, CHIP, AND PROGRAM PRODUCT

(71) Applicant: BEIJING XIAOMI MOBILE SOFTWARE CO., LTD., Beijing (CN)

(72) Inventor: Min LIU, Beijing (CN)

(73) Assignee: BEIJING XIAOMI MOBILE SOFTWARE CO., LTD., Beijing (CN)

(21) Appl. No.: 19/102,436

(22) PCT Filed: Aug. 10, 2022
(86) PCT No.: PCT/CN2022/111531

§ 371 Date: Feb. 10, 2025

(51) Int. Cl. H04B 7/06; H04W 72/044; H04W 72/0453

(52) U.S. Cl. CPC H04B 7/0658; H04B 7/0626; H04W 72/0453; H04W 72/046

(57) ABSTRACT

A communication method is provided. The method includes: determining, based on first information, input information for a channel state information (CSI) compression and encoding model, in which the first information is used to determine a type of the input information for the CSI compression and encoding model.

### CROSS-REFERENCE TO RELATED APPLICATIONS

This application is a U.S. National Phase of International Application No. PCT/CN2022/111531, filed with the State Intellectual Property Office of P.R. China on Aug. 10, 2022, the entire contents of which are incorporated herein by reference.

### TECHNICAL FIELD

The disclosure relates to a field of communication technologies, and in particular to a communication method, an apparatus, a device, a storage medium, a chip and a program product.

### BACKGROUND

Channel state information (CSI) reporting means that a terminal obtains CSI based on measurement of downlink reference signal (e.g., CSI-reference signal (CSI-RS)) sent by a network device, and reports the CSI to the network device according to a report mode and an uplink resource configured by the network device.

In the related art, artificial intelligence (AI)/machine learning (ML) model has introduced into CSI reporting scenarios. For example, the terminal obtains CSI through measurement of downlink RS, obtains compressed and encoded CSI by compressing and encoding the CSI through a CSI compression and encoding model, and then quantizes the compressed and encoded CSI into a binary bit stream and sends the binary bit stream to the network device. The network device dequantizes the received binary bit stream, and then inputs the information obtained after dequantization into a CSI decoding model for decoding to obtain the recovered CSI. The above CSI compression and encoding model and the CSI decoding model may be AI/ML models.

Currently, CSI reporting scenarios to which AI/ML models are introduced require further study.

### SUMMARY

According to a first aspect of embodiments of the disclosure, a communication method is provided. The method is performed by a first device, and includes:
determining input information for a channel state information (CSI) compression and encoding model based on first information, in which the first information is used to determine a type of the input information for the CSI compression and encoding model.

According to a second aspect of embodiments of the disclosure, a communication method is provided. The method is performed by a second device, and includes:
transmitting first information to a first device, in which the first information is used to determine a type of input information for a CSI compression and encoding model.

According to a third aspect of embodiments of the disclosure, a communication device is provided. The communication device includes a processor and a memory. The memory stores a computer program, and the processor executes the computer program to implement the communication method on the first device side or the communication method on the second device side.

According to a fourth aspect of embodiments of the disclosure, a non-transitory computer-readable storage medium is provided. The storage medium stores a computer program, and the computer program is used to be executed by a processor to implement the communication method on the first device side or the communication method on the second device side.

### BRIEF DESCRIPTION OF THE DRAWINGS

The accompanying drawings, which are incorporated in and constitute a part of this specification, illustrate embodiments consistent with the disclosure and, together with the specification, serve to explain the principles of the disclosure.

FIG. 1 is a schematic diagram of a network architecture provided by an exemplary embodiment of the disclosure.

FIG. 2 is a flowchart of a communication method provided by an exemplary embodiment of the disclosure.

FIG. 3 is a flowchart of a communication method provided by a further exemplary embodiment of the disclosure.

FIG. 4 is a flowchart of a communication method provided by a further exemplary embodiment of the disclosure.

FIG. 5 is a block diagram of a communication apparatus provided by an exemplary embodiment of the disclosure.

FIG. 6 is a block diagram of a communication apparatus provided by a further exemplary embodiment of the disclosure.

FIG. 7 is a block diagram of a communication device provided by a further exemplary embodiment of the disclosure.

### DETAILED DESCRIPTION

Reference will now be made in detail to embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods consistent with aspects related to the disclosure as recited in the appended claims.

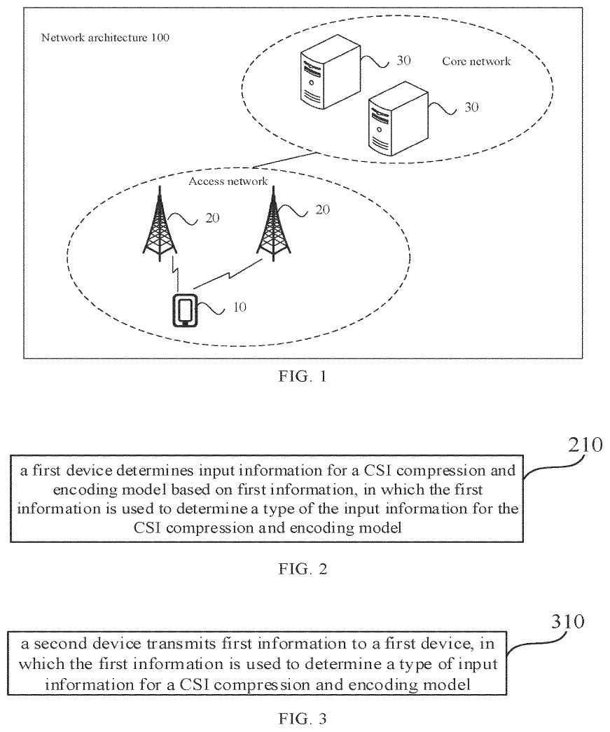

FIG. 1 is a schematic diagram of a network architecture 100 provided by an exemplary embodiment of the disclosure. The network architecture 100 may include a terminal 10, an access network device 20 and a core network device 30.

The terminal 10 may be a user equipment (UE), an access terminal, a user unit, a user station, a mobile station, a mobile site, a remote station, a remote terminal, a mobile device, a wireless communication device, a user agent or a user device. Optionally, the terminal 10 may be a cellular phone, a cordless phone, a session initiation protocol (SIP) phone, a wireless local loop (WLL) station, a personal digital assistant (PDA), a handheld device having a wireless communication function, a computing device or other processing devices connected to a wireless modem, an in-vehicle device, a wearable device, a terminal in a 5th generation system (5GS) or a terminal in a future evolved public land mobile network (PLMN), which is not limited in the embodiment of the disclosure. For convenience of description, the above-mentioned devices are collectively referred to as terminal. Usually, there are a plurality of terminals 10, and one or more terminals 10 may be distributed in each cell managed by the access network device 20. In the embodiment of the disclosure, “terminal” and “UE” are often used interchangeably, but those skilled in the art understand that the two generally express the same meaning.

The access network device 20 is a device deployed in the access network to provide wireless communication functions for the terminal 10. The access network device 20 may include various forms of macro base stations, micro base stations, relay stations, access points, etc. In systems adopting different wireless access technologies, the names of devices with access network device functions may be different. For example, in a 5G new radio (NR) system, it is a next Generation NodeB, which is also called gNodeB (gNB). As communication technologies evolve, the name of “access network device” may change. For the convenience of description, in the embodiments of the disclosure, the above-mentioned devices that provide wireless communication functions for the terminal 10 are collectively referred to as access network device. Optionally, communication can be established between the terminal 10 and the core network device 30 through the access network device 20. For example, in a long term evolution (LTE) system, the access network device 20 may be an evolved universal terrestrial radio access network (EUTRAN) or one or more evolved NodeBs (eNodeBs) in the EUTRAN. In the 5G NR system, the access network device 20 may be a radio access network (RAN) or one or more gNBs in the RAN. In the embodiment of the disclosure, the “network device” mentioned herein, unless otherwise specified, refers to the access network device 20, such as a base station.

The core network device 30 is a device deployed in the core network. The functions of the core network device 30 are mainly to provide user connection, user management and bearer of services, and to be an interface provided by a bearer network to an external network. For example, the core network device in the 5G NR system may include devices such as an access and mobility management function (AMF) entity, a user plane function (UPF) entity and a session management function (SMF) entity.

In some embodiments, the access network device 20 and the core network device 30 communicate with each other through some radio interface technologies, such as an NG interface in the 5G NR system. The access network device 20 and the terminal 10 communicate with each other via some radio interface technologies, such as a Uu interface.

Those skilled in the art understood that “5G NR system” in the embodiment of the disclosure may also be referred to as a 5G system or an NR system. The technical solution described in the embodiment of the disclosure can be applicable to a LTE system, a 5G NR system, future evolved systems of the 5G NR system, and other communication systems such as Narrow Band Internet of Things (NB-IoT) system, which is not limited in the disclosure.

In the embodiment of the disclosure, the network device can provide services for a cell, and the terminal communicates with the network device through transmission resources (e.g., frequency domain or spectrum resources) on carriers used by the cell. The cell may be a cell corresponding to the network device (e.g., a base station), and the cell may belong to a macro base station or a base station corresponding to a small cell. The small cell may include: a Metro cell, a Micro cell, a Pico cell, a Femto cell, etc. These small cells have the characteristics of small coverage and low transmit power, and are suitable for providing high-speed data transmission services.

FIG. 2 is a flowchart of a communication method provided by an exemplary embodiment of the disclosure. The method includes the following step 210.

At step 210, a first device determines input information for a channel state information (CSI) compression and encoding model based on first information, in which the first information is used to determine a type of the input information for the CSI compression and encoding model.

The first device is a device that runs the CSI compression and encoding model, or a device that needs to report CSI. In some embodiments, the first device is a terminal.

The CSI compression and encoding model is an artificial intelligence (AI)/machine learning (ML) model for compressing and encoding CSI. The input information for the CSI compression and encoding model is the information that is fed into the model. For example, the first device (e.g., a terminal) obtains CSI through measurement of reference signal (or pilot signal, such as CSI-reference signal (CSI-RS)) sent by the access network device. The CSI can be directly used as the input information for the CSI compression and encoding model, or the CSI can be used as the input information for the CSI compression and encoding model after being processed. Therefore, the input information for the CSI compression and encoding model can be classified into at least two different types.

In some embodiments, the type includes one of: full channel information, or a feature vector.

In some embodiments, the type includes one of: spatial-frequency domain channel information, angular-delay domain channel information, or a feature vector.

For example, the first device obtains spatial-frequency domain channel information through measurement of RS. The spatial-frequency domain channel information refers to spatial domain channel information and frequency domain channel information. The first device may process the spatial-frequency domain channel information to obtain angular-delay domain channel information. For example, the first device may perform Inverse Discrete Fourier Transform (IDFT) on the spatial-frequency domain channel information to obtain the angular-delay domain channel information. The angular-delay domain channel information refers to channel information related to angular-delay domain. The feature vector refers to feature information extracted from spatial domain channel information and frequency domain channel information obtained by the first device through measurement of RS. The feature information is represented in the form of one or more vector sets. The full channel information may be spatial-frequency domain channel information or angular-delay domain channel information. Both the spatial-frequency domain channel information and the angular-delay domain channel information are full channel information.

In some embodiments, the first information includes explicit indication information configured by a second device. The explicit indication information is used to explicitly indicate a type of the input information for the CSI compression and encoding model. For example, the second device includes one of: an access network device, a core network device, or an application server.

For example, the above explicit indication information is configured by an access network device to the first device. For example, the first device is a terminal, and the access network device transmits CSI reporting configuration information (i.e., CSI report config) to the terminal. The CSI reporting configuration information may include explicit indication information for explicitly indicating the type of the input information for the CSI compression and encoding model. For example, the CSI reporting configuration information is used to configure CSI reporting, and may include, for example, the above-mentioned explicit indication information, and it may also include information for indicating at least one of CSI reporting configurations, such as CSI reporting resources (such as time-frequency resources used for CSI reporting), time-domain characteristics of CSI reporting (such as periodic reporting, semi-static reporting or non-periodic reporting, etc.), and amount of reporting. For example, when the terminal is in a connected state, the access network device transmits the CSI reporting configuration information to the terminal. For example, the CSI reporting configuration information is transmitted via a radio resource control (RRC) signaling.

For example, the above explicit indication information is configured by a core network device to the first device. For example, the first device is a terminal, and the core network device transmits the above-mentioned explicit indication information to the terminal. The core network device can be an existing core network element in the current core network architecture, such as AMF. It can also be a core network element newly added to the current core network architecture, which is not limited in the disclosure.

For example, the above explicit indication information is configured by an application server to the first device. For example, the first device is a terminal, and the application server transmits the above explicit indication information to the terminal. The application server may be a server used to manage and/or provide the above-mentioned CSI compression and encoding model. The application server may be a server in the operator network or a third-party server external to the operator network, which is not limited in the disclosure.

For example, the explicit indication information may occupy at least one bit. For example, the explicit indication information is represented by 1 bit, and a value of 0 indicates that the type of the input information for the CSI compression and encoding model is a full channel information, and a value of 1 indicates that the type of the input information for the CSI compression and encoding model is a feature vector. For example, the explicit indication information is represented by 2 bits, and a value of 00 indicates that the type of input information for the CSI compression and encoding model is spatial-frequency domain channel information, an a value of 01 indicates that the type of input information for the CSI compression and encoding model is angular-delay domain channel information, and a value of 10 indicates that the type of input information for the CSI compression and encoding model is a feature vector. Certainly, the above descriptions of the values and corresponding types of the explicit indication information are only exemplary and explanatory, and the correspondence between the values and types of explicit indication information is not limited in the disclosure.

In some embodiments, the first information includes implicit indication information related to the CSI compression and encoding model. The implicit indication information is used to implicitly indicate the type of the input information for the CSI compression and encoding model. The difference between the implicit indication information and the explicit indication information is that the explicit indication information is information dedicated to indicate the type of input information for the CSI compression and encoding model, while the implicit indication information may have other functions and does not directly indicate the type of input information for the CSI compression and encoding model. However, the type of input information for the CSI compression and encoding model can be indirectly determined or deduced based on the implicit indication information.

For example, the implicit indication information includes at least one of: model parameter information of the CSI compression and encoding model, or model-related information of the CSI compression and encoding model. The model parameter information is used to indicate the structure and/or parameters of the CSI compression and encoding model, and the model-related information is used to indicate information associated with the CSI compression and encoding model.

For example, different types of the input information for the CSI compression and encoding model may correspond to different structure and/or parameters of the CSI compression and encoding model. Therefore, the type of input information for the CSI compression and encoding model may be determined according to the structure and/or parameters of the CSI compression and encoding model.

For example, the CSI compression and encoding model may include an input layer, at least one hidden layer, and an output layer. The input layer is used to receive input information, the at least one hidden layer is used to process the input information, and the output layer is used to output information obtained by the at least one hidden layer. Therefore, in some embodiments, the type of the input information for the CSI compression and encoding model may be determined according to the structure and/or parameters of the input layer of the CSI compression and encoding model. The structure of the input layer may refer to the number of neurons included in the input layer, and the parameters of the input layer may refer to model parameters such as weight parameters corresponding to the neurons included in the input layer. The structure and parameters of the input layer will determine the form in which the input information is input to the model so that it can be correctly processed by the model. For example, if the structure and parameters of the input layer indicate that the input layer requires input vector information, it is determined that the type of input information is a feature vector. If the structure and parameters of the input layer indicate that the input layer requires input channel information, it is determined that the type of input information is full channel information. Further, if the spatial-frequency domain channel information and the angular-delay domain channel information correspond to different structures and/or parameters of the input layer, it may be further determined whether the type of input information is spatial-frequency domain channel information or angular-delay domain channel information based on the structure and/or parameters of the input layer.

For example, the model-related information includes information for directly or indirectly determining the type of input information for the CSI compression and encoding model.

In some embodiments, the model-related information includes information for directly determining the type of input information for the CSI compression and encoding model. For example, the model-related information includes a type identifier for indicating the type of input information for the CSI compression and encoding model. For example, if the type identifier is 0, it indicates that the type of input information is full channel information, and the type identifier of 1 indicates that the type of input information is feature vector. For another example, the type identifier of 00 indicates that the type of input information is spatial-frequency domain channel information, the type identifier of 01 indicates that the type of input information is angular-delay domain channel information, and the type identifier of 10 indicates that the type of input information is feature vector. Certainly, the above-mentioned mapping relationships between the values of the type identifier and the types of input information are only exemplary and explanatory, and the value of the type identifier corresponding to individual type are not specifically limited in the disclosure.

In some embodiments, the model-related information includes information for indirectly determining the type of input information for the CSI compression and encoding model. For example, the model-related information includes information indicating the structure and/or parameters of the input layer of the CSI compression and encoding model. The structure and/or parameters of the input layer of the CSI compression and encoding model can be determined according to the information, and then according to the structure and/or parameters of the input layer, the type of input information for the CSI compression and encoding model can be determined. The specific methods and examples for determining the type of input information according to the structure and/or parameters of the input layer can be referred to the above contents and will not be repeated here.

For example, the implicit indication information is provided by a second device to the first device. The second device includes one of: an access network device, a core network device, or an application server. The introduction of the second device can be referred to the above contents and will not be repeated here.

In some embodiments, the first information includes information specified by a protocol. For example, the protocol specifies that the type of input information for the CSI compression and encoding model is full channel information or feature vector. For example, the protocol specifies that the type of input information for the CSI compression and encoding model is spatial-frequency domain channel information, angular-delay domain channel information, or feature vector.

For example, the first information includes a type corresponding to at least one scenario specified by the protocol. For example, the protocol specifies that in a first scenario, the type of input information is full channel information, and in a second scenario, the type of input information is feature vector, wherein the first scenario and the second scenario are two different scenarios. The first device may determine the type of input information for the CSI compression and encoding model by combining the first information and the current scenario. For example, if the current scenario is the first scenario, the type of input information for the CSI compression and encoding model is determined to be full channel information. If the current scenario is the second scenario, the type of input information for the CSI compression and encoding model is determined to be feature vector.

In some embodiments, the type of input information for the CSI compression and encoding model is determined by combining the explicit indication information configured by the second device and the information specified by the protocol. For example, the explicit indication information configured by the access network device indicates that the type of input information is full channel information, and the protocol specifies that the above full channel information is spatial-frequency domain channel information, then the terminal determines that the type of input information for the CSI compression and encoding model is spatial-frequency domain channel information.

In some embodiments, when the type of input information for the CSI compression and encoding model is spatial-frequency domain channel information, the input information is determined according to the number of receiving antenna ports, the number of transmitting antenna ports and RS frequency domain information. The number of receiving antenna ports refers to the number of antenna ports of devices that receive the above RS. The number of transmitting antenna ports refers to the number of antenna ports of devices that transmit the above RS. The RS frequency domain information may be the number of frequency domain units contained in a frequency band in which the RS is located. The frequency domain unit may be a resource block (RB), a sub-carrier, or a sub-band. Certainly, it may include other forms of frequency domain units, which is not limited in the disclosure.

For example, the access network device transmits a RS (such as a CSI-RS) to the terminal, and the terminal measures the RS and performs CSI reporting. In this scenario, in a case that the type of input information for the CSI compression and encoding model is spatial-frequency domain channel information, the input information is determined based on the number of antenna ports of the terminal, the number of antenna ports of the access network device, and the number of frequency domain units contained in a frequency band in which the RS is located. For example, the input information is matrix information of the number of antenna ports of the terminal*the number of antenna ports of the access network device*the number of frequency domain units contained in the frequency band in which the RS is located, where * represents multiplication.

In some embodiments, in a case that the type of input information for the CSI compression and encoding model is angular-delay domain channel information, the input information is determined based on the number of receiving antenna ports, the number of transmitting antenna ports and delay domain information of the channel. The introductions to the number of receiving antenna ports and the number of transmitting antenna ports can be referred to the above contents. The delay domain information of the channel can be determined based on the spatial-frequency domain channel information. For example, the angular-delay domain channel information is obtained by performing IDFT on the spatial-frequency domain channel information, and then the delay domain information of the channel is determined from the angular-delay domain channel information. The delay domain information of the channel may include delay domain information of part of frequency domain units, which refers to part of frequency domain units included in the frequency band in which the RS is located, i.e., a part of frequency domain units in all frequency domain units included in the frequency band in which the RS is located. Similarly, the frequency domain unit may be an RB, a sub-carrier, or a sub-band. Certainly, it may include other forms of frequency domain units, which is not limited in the disclosure.

For example, the access network device transmits a RS (such as a CSI-RS) to the terminal, and the terminal measures the RS and performs CSI reporting. In this scenario, if the type of input information for the CSI compression and encoding model is angular-delay domain channel information, the input information is determined based on the number of antenna ports of the terminal, the number of antenna ports of the access network device and delay domain information of the channel. For example, the input information is matrix information of the number of antenna ports of the terminal * the number of antenna ports of the access network device*the number of the part of frequency domain units, where * represents multiplication. Since multipath delays are usually limited, the similarity of the same sample between different time domain units is high, so a channel matrix H exhibits high sparsity, and elements at larger delays are mostly 0. Therefore, reserving the first Nc row of elements can greatly reduce the amount of information, where Nc represents the number of the part of frequency domain units, which is determined by the first device.

In some embodiments, in a case that the type of input information for the CSI compression and encoding model is feature vector, the input information is determined according to a matrix decomposition result of a measured channel information. If the type of input information for the CSI compression and encoding model is feature vector, the content of the input information is one or more columns (two or more columns) of feature vectors. For example, the first device performs Singular Value Decomposition (SVD) on the measured spatial-frequency domain channel information, and determines the content of the input information according to the feature vectors and feature values obtained by decomposition.

The technical solution provided in the embodiment of the disclosure determines the input information for the CSI compression and encoding model according to the first information used to determine the type of input information for the CSI compression and encoding model, which clarifies the method for determining the input information for the CSI compression and encoding model, helps different devices to have a consistent understanding of the input information for the CSI compression and encoding model, and improves the accuracy and reliability of CSI encoding and decoding.

In addition, the embodiment of the disclosure provides a plurality of ways to determine the type of input information for the CSI compression and encoding model, including explicit indication, implicit indication, protocol specification, or a combination of the above ways, thereby improving the flexibility of determining the type.

In addition, the embodiment of the disclosure provides for different types, a method to determine input information under the type, so that the input information of the model conforms to the specifications of the corresponding type, which further ensures the accuracy and reliability of CSI encoding and decoding.

FIG. 3 is a flowchart of a communication method provided by an exemplary embodiment of the disclosure. The method may include the following step 310.

At step 310, a second device transmits first information to a first device, in which the first information is used to determine a type of input information for a CSI compression and encoding model.

In some embodiments, the second device includes one of: an access network device, a core network device or an application server.

In some embodiments, the type includes one of: full channel information, or a feature vector.

In some embodiments, the type includes one of: spatial-frequency domain channel information, angular-delay domain channel information, or a feature vector.

In some embodiments, the first information includes explicit indication information. The explicit indication information is used to explicitly indicate the type of input information for the CSI compression and encoding model.

In some embodiments, the first information includes implicit indication information related to the CSI compression and encoding model. The implicit indication information is used to implicitly indicate the type of input information for the CSI compression and encoding model. For example, the implicit indication information includes at least one of: model parameter information of the CSI compression and encoding model, or model-related information of the CSI compression and encoding model. The model parameter information is used to indicate the structure and/or parameters of the CSI compression and encoding model, and the model-related information is used to indicate associated information of the CSI compression and encoding model.

In some embodiments, if the type of input information for the CSI compression and encoding model is spatial-frequency domain channel information, the input information is determined according to the number of receiving antenna ports, the number of transmitting antenna ports and RS frequency domain information.

In some embodiments, if the type of input information for the CSI compression and encoding model is angular-delay domain channel information, the input information is determined according to the number of receiving antenna ports, the number of transmitting antenna ports and delay domain channel information.

In some embodiments, if the type of input information for the CSI compression and encoding model is feature vector, the input information is determined according to a vector decomposition result of measured channel information.

The contents not described in detail in this embodiment can be referred to the introduction of the method embodiment shown in FIG. 2 above, and no further details will be given here.

In the technical solution provided in the embodiment of the disclosure, the second device transmits the first information to the first device, so that the first device can determine the type of input information for the CSI compression and encoding model according to the first information, and then determine the input information for the CSI compression and encoding model, which clarifies the method for determining the input information for the CSI compression and encoding model, helps different devices to have a consistent understanding of the input information for the CSI compression and encoding model, and improves the accuracy and reliability of CSI encoding and decoding.

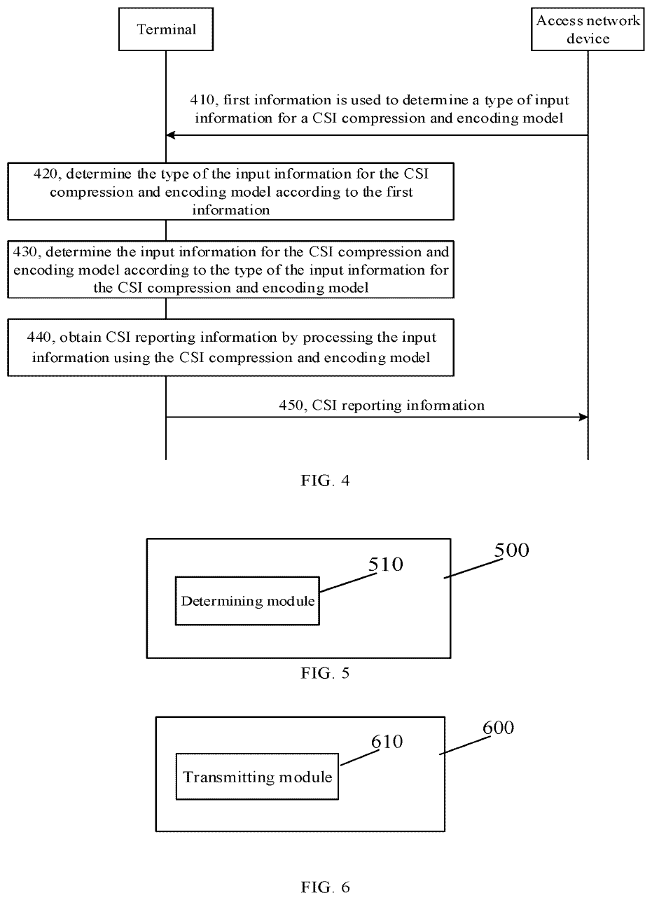

FIG. 4 is a flowchart of a communication method provided by an exemplary embodiment of the disclosure. In this embodiment, the first device is a terminal, and the second device is an access network device. The method may include at least one of the following steps 410-450.

At step 410, the access network device transmits first information to the terminal, in which the first information is used to determine the type of input information for the CSI compression and encoding model.

For example, the first information includes explicit indication information. The explicit indication information is used to explicitly indicate the type of input information for the CSI compression and encoding model. For example, the access network device transmits the CSI reporting configuration information (i.e., CSI report config) to the terminal, in which the CSI reporting configuration information may include the above-mentioned explicit indication information.

At step 420, the terminal determines the type of input information for the CSI compression and encoding model according to the first information.

For example, the terminal determines the type of input information for the CSI compression and encoding model according to the above explicit indication information. For example, if the type indicated by the explicit indication information is spatial-frequency domain channel information, the terminal determines that the type of input information for the CSI compression and encoding model is spatial-frequency domain channel information. If the type indicated by the explicit indication information is angular-delay domain channel information, the terminal determines that the type of input information for the CSI compression and encoding model is angular-delay domain channel information. If the type indicated by the explicit indication information is feature vector, the terminal determines that the type of input information for the CSI compression and encoding model is feature vector.

At step 430, the terminal determines input information for the CSI compression and encoding model according to the type of input information for the CSI compression and encoding model.

During the CSI reporting process, the access network device may transmit a RS (such as a CSI-RS) to the terminal, and the terminal obtains spatial-frequency domain channel information through measurement of RS. If the type of input information for the CSI compression and encoding model determined by the terminal is spatial-frequency domain channel information, the terminal can directly use the measured spatial-frequency domain channel information as the input information for the CSI compression and encoding model. If the type of input information for the CSI compression and encoding model determined by the terminal is angular-delay domain channel information, the terminal performs IDFT on the spatial-frequency domain channel information obtained by measurement to obtain angular-delay domain channel information, and then uses the angular-delay domain channel information as the input information for the CSI compression and encoding model. If the type of input information for the CSI compression and encoding model determined by the terminal is feature vector, the terminal may process the above spatial-frequency domain channel information, extract feature vectors from it and use the feature vectors as the input information for the CSI compression and encoding model.

At step 440, the terminal processes the input information through the CSI compression and encoding model to obtain CSI reporting information.

The terminal inputs the above input information into the CSI compression and encoding model to compress and encode the input information, in order to obtain the CSI reporting information. In some embodiments, the input information is compressed and encoded firstly, and then quantized to obtain the CSI reporting information in the form of a binary bit stream. The quantization step can be completed inside the CSI compression and encoding model or outside the CSI compression and encoding model, which is not limited in the disclosure.

At step 450, the terminal transmits the CSI reporting information to the access network device.

After receiving the above CSI reporting information, the access network device may dequantize the CSI reporting information in the form of a binary bit stream, and then input it into a CSI decoding model for decoding to obtain recovered CSI.

The embodiments of the disclosure provide the technical solution that enable a consensus between the terminal and the access network device can have a of the input information for the CSI compression and encoding model regarding the understanding of the input information of the CSI compression coding model by the access network device providing the terminal with information for determining the type of input information for the CSI compression and encoding model. The CSI compression and recovery architecture based on the bilateral AI/ML model of encoder (i.e., the CSI compression and encoding model described above) and decoder (i.e., the CSI decoding model described above) is helpful to improve the accuracy and reliability of CSI coding and decoding.

It should be noted that the above steps performed by the first device can be independently implemented as a communication method on the first device side, and the above steps performed by the second device can be independently implemented as a communication method on the second device side.

An apparatus of the embodiment of the disclosure is provided below, which can be used to execute the method embodiments of the disclosure. The contents not disclosed in the embodiment of the disclosure relating to the apparatus can be referred to the method embodiments of the disclosure.

FIG. 5 is a block diagram of a communication apparatus provided by an exemplary embodiment of the disclosure. The apparatus has the function of implementing the method on the first device side described above. The function can be implemented by hardware or by executing corresponding software through hardware. The apparatus may be the first device described above, or may be arranged in the first device. As illustrated in FIG. 5, the apparatus 500 includes: a determining module 510.

The determining module 510 is configured to determine input information for a CSI compression and encoding model according to first information, in which the first information is used to determine a type of input information for the CSI compression and encoding model.

In some embodiments, the type includes one of: full channel information, or a feature vector. Or, the type includes one of: spatial-frequency domain channel information, angular-delay domain channel information, or a feature vector.

In some embodiments, the first information includes explicit indication information configured by a second device, and the explicit indication information is used to explicitly indicate the type of input information for the CSI compression and encoding model.

In some embodiments, the second device includes one of: an access network device, a core network device and an application server.

In some embodiments, the first information includes implicit indication information related to the CSI compression and encoding model, and the implicit indication information is used to implicitly indicate the type of input information for the CSI compression and encoding model.

In some embodiments, the implicit indication information includes at least one of:
model parameter information of the CSI compression and encoding model, wherein the model parameter information is used to indicate the structure and/or parameters of the CSI compression and encoding model; or
model-related information of the CSI compression and encoding model, in which the model-related information is used to indicate associated information of the CSI compression and encoding model.

In some embodiments, the first information includes information specified by a protocol.

In some embodiments, in a case that the type is spatial-frequency domain channel information, the input information is determined according to the number of receiving antenna ports, the number of transmitting antenna ports and RS frequency domain information.

In some embodiments, in a case that the type is angular-delay domain channel information, the input information is determined according to the number of receiving antenna ports, the number of transmitting antenna ports and delay domain channel information.

In some embodiments, in a case that the type is feature vector, the input information is determined according to a vector decomposition result of measured channel information.

In some embodiments, the first device is a terminal.

FIG. 6 is a block diagram of a communication apparatus provided by an exemplary embodiment of the disclosure. The apparatus has the function of implementing the method on the second device side described above. The function can be implemented by hardware or by executing corresponding software through hardware. The apparatus may be the second device described above, or may be arranged in the second device. As illustrated in FIG. 6, the apparatus 600 includes: a transmitting module 610.

The transmitting module 610 is configured to transmit first information to a first device, in which the first information is used to determine a type of input information for a CSI compression and encoding model.

In some embodiments, the type includes one of: full channel information, or a feature vector, or, the type includes one of: spatial-frequency domain channel information, angular-delay domain channel information, or a feature vector.

In some embodiments, the first information includes explicit indication information, and the explicit indication information is used to explicitly indicate the type of input information for the CSI compression and encoding model.

In some embodiments, the first information includes implicit indication information related to the CSI compression and encoding model, and the implicit indication information is used to implicitly indicate the type of input information for the CSI compression and encoding model.

In some embodiments, the implicit indication information includes at least one of:
model parameter information of the CSI compression and encoding model, in which the model parameter information is used to indicate the structure and/or parameters of the CSI compression and encoding model; or
model-related information of the CSI compression and encoding model, in which the model-related information is used to indicate associated information of the CSI compression and encoding model.

In some embodiments, in a case that the type is spatial-frequency domain channel information, the input information is determined according to the number of receiving antenna ports, the number of transmitting antenna ports and RS frequency domain information.

In some embodiments, in a case that the type is angular-delay domain channel information, the input information is determined according to the number of receiving antenna ports, the number of transmitting antenna ports and delay domain channel information.

In some embodiments, in a case that the type is feature vector, the input information is determined according to a vector decomposition result of measured channel information.

In some embodiments, the second device includes one of: an access network device, a core network device or an application server.

It should be noted that when the apparatus provided in the above embodiment implements its functions, the classification of the above functional modules is described as an example. In practical applications, the above-mentioned functions are assigned to different functional modules according to actual needs, which means that the content structure of the apparatus is divided into different functional modules to complete all or part of the functions described above.

Regarding the apparatus in the above embodiment, the specific manner in which each module performs operations has been described in detail in the method embodiment, and will not be repeated here. The contents not described in detail in the apparatus embodiment can be referred to the above method embodiment.

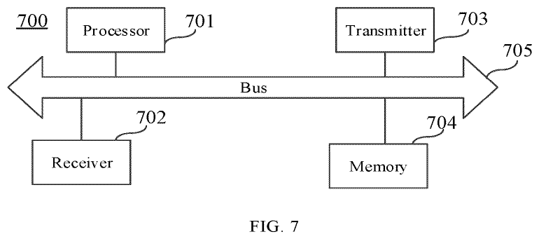

FIG. 7 is a block diagram of a communication device 700 according to an exemplary embodiment. The communication device 700 may be the above first device or second device. The communication device 700 includes: a processor 701, a receiver 702, a transmitter 703, a memory 704 and a bus 705. The processor 701 is used to implement the function of the processing module in the above-mentioned apparatus embodiment, the receiver 702 can be used to implement the function of the receiving module in the above-mentioned apparatus embodiment, and the transmitter 703 can be used to implement the function of the sending module in the above-mentioned apparatus embodiment.

The processor 701 includes one or more processing cores, and the processor 701 executes various functional applications and information processing by running software programs and modules.

The receiver 702 and the transmitter 703 can be realized as a communication component, which may be a communication chip.

The memory 704 is connected to the processor 701 through the bus 705.

The memory 704 is used to store a computer program, and the processor 701 is used to execute the computer program to realize the communication method on the first device side or the communication method on the second device side.

In addition, the memory 704 can be implemented by any type of volatile or non-volatile storage device or a combination thereof. The volatile or non-volatile storage device includes but is not limited to: a magnetic disk or an optical disk, an electrically erasable programmable read-only memory (EEPROM), an erasable programmable read-only memory (EPROM), a static random-access memory (SRAM), a read-only memory (ROM), a magnetic memory, a flash memory, and a programmable read-only memory (PROM).

The embodiment of the disclosure also provides a computer-readable storage medium having a computer program stored therein. The computer program is used to be executed by a processor to implement the above-mentioned communication method on the first device side or the communication method on the second device side. Optionally, the computer-readable storage medium may include: a ROM, a random-access memory (RAM), a solid state drive (SSD) or an optical disk, etc. The RAM may include a resistance RAM (ReRAM) and a Dynamic RAM (DRAM).

The embodiment of the disclosure also provides a communication system, which includes a first device and a second device. The first device is used to realize the communication method on the first device side, and the second device is used to realize the communication method on the second device side.

The embodiment of the disclosure also provides a chip, which includes a programmable logic circuit and/or program instructions. When the chip is running, the communication method on the first device side or the communication method on the second device side is implemented.

The embodiment of the disclosure also provides a computer program product, which includes computer instructions stored in a computer-readable storage medium. A processor reads the computer instructions from the computer-readable storage medium and executes the computer instructions to realize the communication method on the first device side or the communication method on the second device side.

It should be understood that “indicating” mentioned in the embodiment of the disclosure may be direct indicating, indirect indicating, or indicating an association relationship. For example, if A indicates B, A may directly indicates B, which means that B can be obtained through A, or A may indirectly indicate B, for example, A indicates C, and B can be obtained through C, or it may indicate that there is an association relationship between A and B.

In the description of the embodiment of the disclosure, the term “correspondence” may indicate that there is a direct or indirect correspondence between the two, or that there is an association relationship between the two, or that there is an indication or configuration relationship between the two.

In some embodiments of the disclosure, “predefining” can be realized by pre-storing corresponding codes, tables or other means that can be used to indicate relevant information in the devices (for example, the first device and the second device), and its specific implementation is not limited in the disclosure. For example, predefining can refer to defining in a protocol.

In some embodiments of the disclosure, the “protocol” may refer to a standard protocol in the communication field, including, for example, a LTE protocol, a NR protocol and related protocols applied in future communication systems, which is not limited in the disclosure.

As used herein, “a plurality of” means two or more, and “and/or” describes an association relationship of associated objects, which can be used to indicate three kinds of relationships. For example, “A and/or B” indicates that A exists alone, A and B both exist, and B exists alone. The character “/” generally indicates that the associated objects before and after the character “/”are in an “or”relationship.

The term “greater than or equal to” mentioned herein means “greater than or equal to” or “greater than”, and the term “less than or equal to” means “less than or equal to” or “less than”.

In addition, the serial numbers of steps described in the disclosure only illustrate a possible execution order of steps. In some other embodiments, the above steps may not be executed in the sequence indicated by the serial numbers. For example, two steps with different serial numbers may be executed at the same time, or two steps with different serial numbers are executed in the opposite order to that shown in the figure, which is not limited in the disclosure.

In addition, the embodiments provided in the disclosure may be arbitrarily combined and form new embodiments, which are all within the protection scope of the disclosure.

Those skilled in the art understand that in one or more of the above examples, the functions described in the embodiments of the disclosure can be implemented by hardware, software, firmware or any combination thereof. When implemented using software, the functions may be stored in a computer-readable medium or transmitted as one or more instructions or codes on the computer-readable medium. The computer-readable medium includes both a computer storage medium and a communication medium. The communication medium may include any medium that facilitates transfer of computer programs from one place to another, and the storage medium may be any available medium that can be accessed by a general purpose computer or a dedicated computer.

The above description is only an exemplary embodiment of the disclosure and is not intended to limit the disclosure. Any modification, equivalent substitution, improvement, etc. made within the spirit and principles of the disclosure shall be included in the protection scope of the disclosure.

1. A communication method, performed by a first device, comprising:
determining, based on first information, input information for a channel state information (CSI) compression and encoding model, wherein the first information is used to determine a type of the input information for the CSI compression and encoding model.

2. The method of claim 1, wherein
the type comprises one of:
full channel information,
spatial-frequency domain channel information;
angular-delay domain channel information; or
a feature vector.

3. The method of claim 1, wherein the first information comprises explicit indication information configured by a second device, and the explicit indication information is used to explicitly indicate the type of the input information for the CSI compression and encoding model.

4. The method of claim 3, wherein the second device comprises one of: an access network device, a core network device or an application server.

5. The method of claim 1, wherein the first information comprises implicit indication information related to the CSI compression and encoding model, and the implicit indication information is used to implicitly indicate the type of the input information for the CSI compression and encoding model.

6. The method of claim 5, wherein the implicit indication information comprises at least one of:
model parameter information of the CSI compression and encoding model, wherein the model parameter information is used to indicate at least one of a structure or parameters of the CSI compression and encoding model; or
model-related information of the CSI compression and encoding model, wherein the model-related information is used to indicate associated information of the CSI compression and encoding model.

7. The method of claim 1, wherein the first information comprises information specified by a protocol.

8. The method of claim 2, wherein in a case that the type is the spatial-frequency domain channel information, the input information is determined according to a number of receiving antenna ports, a number of transmitting antenna ports and reference signal frequency domain information; or
wherein in a case that the type is the angular-delay domain channel information, the input information is determined according to a number of receiving antenna ports, a number of transmitting antenna ports and delay domain channel information; or
wherein in a case that the type is the feature vector, the input information is determined according to a vector decomposition result of measured channel information.

11. The method of claim 1, wherein the first device is a terminal.

12. A communication method, performed by a second device, comprising: transmitting first information to a first device, wherein the first information is used to determine a type of input information for a channel state information (CSI) compression and encoding model.

13. The method of claim 12, wherein
the type comprises one of:
full channel information,
spatial-frequency domain channel information;
angular-delay domain channel information; or
a feature vector.

14. The method of claim 12, wherein the first information comprises explicit indication information, and the explicit indication information is used to explicitly indicate the type of the input information for the CSI compression and encoding model.

15. The method of claim 12, wherein the first information comprises implicit indication information related to the CSI compression and encoding model, and the implicit indication information is used to implicitly indicate the type of the input information for the CSI compression and encoding model.

16. The method of claim 15, wherein the implicit indication information comprises at least one of:
model parameter information of the CSI compression and encoding model, wherein the model parameter information is used to indicate at least one of a structure or parameters of the CSI compression and encoding model; or
model-related information of the CSI compression and encoding model, wherein the model-related information is used to indicate associated information of the CSI compression and encoding model.

17. The method of claim 13, wherein in a case that the type is the spatial-frequency domain channel information, the input information is determined according to the number of receiving antenna ports, the number of transmitting antenna ports and reference signal frequency domain information; or
wherein in a case that the type is the angular-delay domain channel information, the input information is determined according to the number of receiving antenna ports, the number of transmitting antenna ports and delay domain channel information; or
wherein in a case that the type is feature vector, the input information is determined according to a vector decomposition result of measured channel information.

18-19. (canceled)

20. The method of claim 12, wherein the second device comprises one of: an access network device, a core network device or an application server.

21-22. (canceled)

23. A communication device, comprising a processor and a memory having a computer program stored therein, wherein the processor is configured to:
determine, based on first information, input information for a channel state information (CSI) compression and encoding model, wherein the first information is used to determine a type of the input information for the CSI compression and encoding model.

24. A non-transitory computer-readable storage medium, wherein the storage medium stores a computer program, and the computer program is used to be executed by a processor to implement the method according to claim 1.

25-26. (canceled)

27. A communication device, comprising a processor and a memory storing instructions executable by the processor, wherein the processor is configured to execute the method according to claim 12.

28. A non-transitory computer-readable storage medium storing instructions that are executed by a processor to perform the method according to claim 12.
